(19) United States
(12) Patent Application Publication
(10) Pub. No.: US 2017/0161232 A1
(43) Pub. Date: Jun. 8, 2017

(54) METHOD AND ELECTRONIC DEVICE FOR CONFIGURING A VIDEO PLAYER IN A WEB PAGE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Kaixuan YANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,330

(22) Filed: Aug. 22, 2016

Related U.S. Application Data
(63) Continuation of application No. PCT/CN2016/089510, filed on Jul. 10, 2016.

(30) Foreign Application Priority Data
Dec. 8, 2015 (CN) 201510900283X

(51) Int. Cl. G06F 17/21; G06T 3/40; G06T 11/60; G06F 17/22; G06F 17/24

(52) U.S. Cl. CPC G06F 17/212; G06F 17/2247; G06F 17/24; G06T 11/60; G06T 3/40; G06F 17/2211

(57) ABSTRACT

Embodiments of the present disclosure provide a method and an electronic device for configuring a video player in a web page. The method includes: acquiring in real time a size of an initial screen of a browser, in response to an operation of showing a video player playing a video in a web page; and setting a size of the player according to the size of the initial screen of the browser, so that the player is entirely shown in an initial screen page of the browser. A technical solution of the present disclosure can enable a player shown in an initial screen of a browser to adaptively change as a size of a browser page changes, so that a user can always view a complete player picture.

### CROSS REFERENCE TO RELATED APPLICATIONS

This application is a continuation of International Application No. PCT/CN2016/089510, with an international filing date of Jul. 10, 2016, which is based upon and claims priority to Chinese Patent Application No. 201510900283.X, filed on Dec. 8, 2015, the entire contents of all of which are incorporated herein by reference.

### TECHNICAL FIELD

The present disclosure relates to information processing technologies, and in particular, to a method and an electronic device for configuring a video player in a web page.

### BACKGROUND

Currently, screens of users' computer displays have different sizes, and toolbars of used browsers have different heights; as a result, initial screens have different areas. When a user opens a video player in an initial screen page of a browser, and the initial screen page of the browser is not in a full-screen state, or the user stretches a browser page to be in a random size state, the player is often screen-divided, that is, a partial picture of an entire original player picture is shown, which imposes an unfavorable effect on user experience in viewing a video.

### SUMMARY

Some embodiments of the present disclosure provide a method and an electronic device for configuring a video player in a web page, which can enable a player shown in an initial screen of a browser to adaptively change as a size of a browser page changes, so that a user can always view a complete player picture.

To achieve the foregoing objective, an embodiment of the present disclosure provides a method for configuring a video player in a web page. The method includes: acquiring in real time a size of an initial screen of a browser, in response to an operation of showing a video player playing a video in a web page; and setting a size of the player according to the size of the initial screen of the browser, so that the player is entirely shown in an initial screen page of the browser.

According to an embodiment of the present disclosure, there is provided with a non-transitory computer-readable storage medium storing executable instructions that, when executed by an electronic device, cause the electronic device to perform an above disclosed method.

According to an embodiment of the present disclosure, there is provided with an electronic device. The electronic device includes: at least one processor; and a memory communicably connected with the at least one processor for storing instructions executable by the at least one processor, wherein execution of the instructions by the at least one processor causes the at least one processor to perform an above disclosed method.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for configuring a video player in a web page according to an embodiment of the present disclosure;

FIG. 2 is a flowchart of a method for configuring a video player in a web page according to another embodiment of the present disclosure;

FIG. 3 is an exemplary diagram of a relationship between a player and a picture in the player according to an embodiment of the present disclosure;

FIG. 4 is an exemplary diagram of a play effect of a picture in a player according to an embodiment of the present disclosure;

FIG. 5 is a schematic structural diagram of an apparatus for configuring a video player in a web page according to an embodiment of the present disclosure;

FIG. 6 is a schematic structural diagram of an apparatus for configuring a video player in a web page according to another embodiment of the present disclosure; and,

FIG. 7 illustrates a schematic hardware diagram of an electronic device for according to an embodiment of the present disclosure.

### DETAILED DESCRIPTION

A basic inventive concept of some embodiments of the present disclosure is: when a player is opened by using a browser to play a video, a size of the player is adjusted always adapting to a size of the browser, so that the player is always entirely shown in an initial screen page of the browser. The initial screen page of the browser is the first screen page that is automatically shown after the browser is opened.

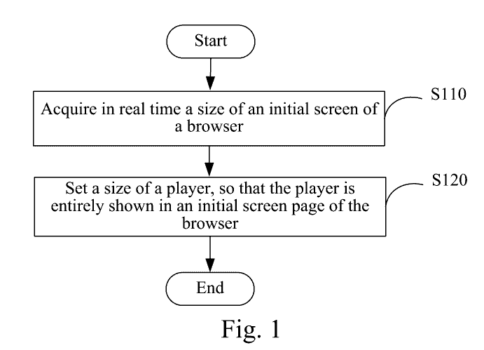

FIG. 1 is a flowchart of a method for configuring a video player in a web page according to an embodiment of the present disclosure. The method may be executed by browser devices applied to various PCs, or apparatuses integrated in these browser devices. This solution is described by using a browser as an executive body.

Referring to FIG. 1, in step S110: a size of an initial screen of a browser is in real time acquired, in response to an operation of showing a video player playing a video in a web page.

In this embodiment, the size of the initial screen of the browser refers to a pixel size of the first screen page of the pages in which the player is opened by the browser. In an existing processing method for showing a player in a browser, the player is shown in a fixed player picture proportion, and when a user drags and stretches the browser, the corresponding player is always shown in a fixed picture size. As a result, a page of the player cannot be entirely shown in the browser when a size of an initial screen page is adjusted by the user to a smaller size. To overcome disadvantages of prior art, in this embodiment, when a player is shown by a browser page, a size of an initial screen page of the browser is acquired in real time, and a size of the player is adaptively adjusted according to an actual size of a current page of the browser.

In Step S120, a size of the player is set according to the size of the initial screen of the browser, so that the player is entirely shown in an initial screen page of the browser.

When a size of the initial screen page of the browser when the player is just opened is acquired, or the size of the initial screen changes caused by a user adjusting a page size of the browser, an actual size of the player may be adjusted according to an actual size of the initial screen page, so that the player is always entirely shown in a current initial screen page.

When the size of the player is to be adjusted, equal proportion adjustment may be performed according to a source video proportion of a played video until the player is adjusted to a suitable size, or adaptive horizontal or vertical size extension may be performed on the size of the player in an original source video proportion, or a largest size of all source video proportions is selected as the most suitable size of the player. A manner in which the size of the player is adjusted is not limited in this embodiment, as long as the adjusted size of the player is always shown in a current initial screen page in a full-screen manner.

The method for configuring a video player in a web page provided in this embodiment acquires a size of an initial screen of a browser by checking in real time to adjust a size of a player and to ensure that the player is entirely shown in an initial screen page of the browser, thereby meeting a requirement of a user for viewing a complete video picture.

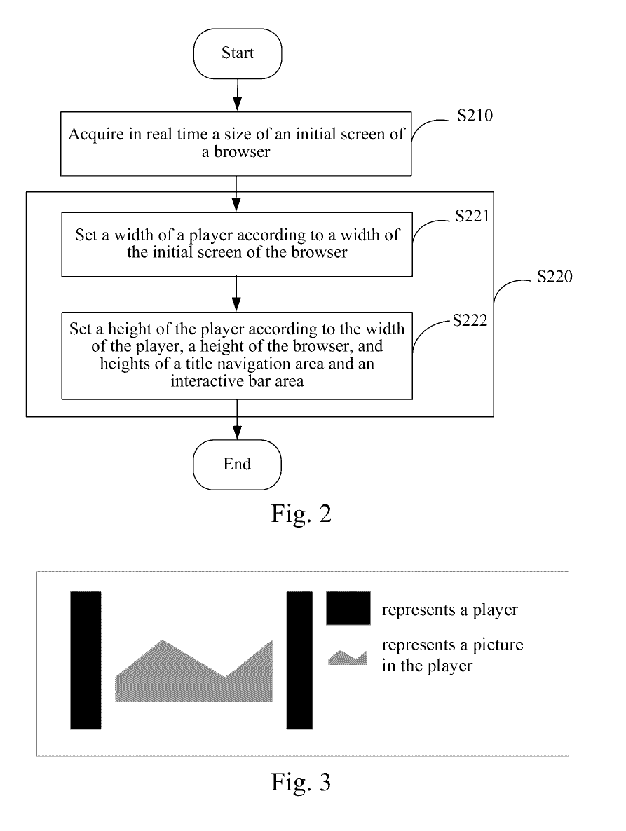

FIG. 2 is a flowchart of a method for configuring a video player in a web page according to another embodiment of the present disclosure, and is a specific implementation manner of the method embodiment shown in FIG. 1.

As shown in FIG. 2, in Step S210, a size of an initial screen of a browser is acquire in real time, in response to an operation of showing a video player playing a video in a web page. S210 and S110 have similar content.

Generally, an initial screen of a browser having a player includes: a title navigation area located above the player and an interactive bar area located below the player, and the two areas have fixed heights and sizes.

In Step S220, a size of the player is set according to the size of the initial screen of the browser, so that the player is entirely shown in an initial screen page of the browser. S220 and S120 have similar content.

Based on a width of the initial screen of the browser and heights and sizes of the title navigation area and the interactive bar area in the initial screen, this embodiment provides an implementation example of setting the size of the player, including S221 and S222.

In S221, a width of the player is set according to a width of the initial screen of the browser.

After a width of the browser is acquired, the width of the player may be adaptively adjusted according to a page display size provided by the browser. For example, multiple width settings may be set according to different width ranges, and each setting corresponds to one suitable player width value.

For example, as shown in Table 1, three width settings are set for a page width of the browser in this embodiment, and each setting corresponds to one browser width size and a corresponding player width threshold, where each width range corresponds to one player width threshold, and the larger a width value of a width range is, the larger the player width threshold is. After a size of a current initial screen width of the browser is acquired, a preset width range in Table 1 to which the initial screen width of the browser belongs may be identified, and a player width threshold that corresponds to the corresponding width range is determined as a current width of the player.

TABLE 1
Player width configuration table

| Setting | Browser width | Player width threshold |
|---|---|---|
| 1024 | Less than or equal to 1024 | 948 |
| 1280 | Greater than 1024 and less than 1440 | 1164 |
| 1440 | Greater than or equal to 1440 | 1324 |

In S222, a height of the player is set according to the width of the player, a height of the browser, and heights of the title navigation area and the interactive bar area.

When the height of the player is set, not only an available height provided by the current initial screen of the browser for the player, but also the width of the player need to be taken into consideration, to ensure that a play picture has a suitable length-to-width ratio to provide a user with a suitable viewing effect.

For example, a difference is firstly calculated by subtracting the heights of the title navigation area and the interactive bar area from the height of the browser, where the difference may be understood as an available height provided by the current initial screen of the browser for the player. Meanwhile to ensure the quality of a play picture, in this embodiment, a minimum size of the height of the player, that is, a first threshold, and a maximum size of the height of the player, that is, a second threshold, are preset. The first threshold is a constant value, for example, a pixel size 474; and the second threshold is a size that is in proportion to the width of the player, for example, a ratio of the width of the player to a source video proportion of a video played by the player. For example, when the width of the player is W, and the source video proportion of the video is a, the height of the player=W/a.

Based on the difference that is obtained by subtracting the heights of the title navigation area and the interactive bar area from the height of the browser, and a preset first threshold and second threshold, an example of determining the height of the player is provided below:

if the height difference is less than or equal to a first threshold, determining the first threshold to be the height of the player; or if the height difference is greater than the first threshold and is less than a second threshold, determining the height difference to be the height of the player; or if the height difference is greater than or equal to a second threshold, determining the second threshold to be the height of the player.

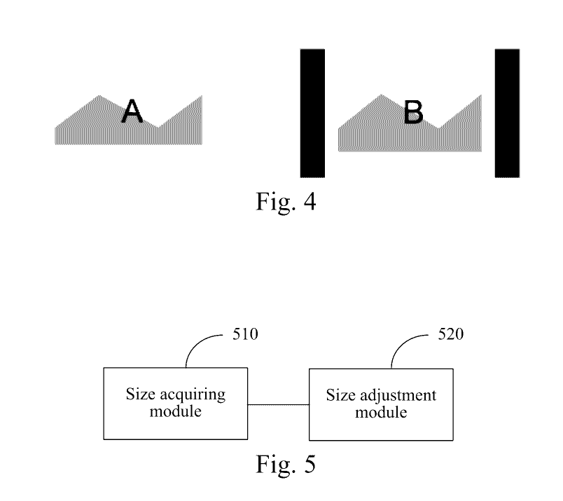

FIG. 3 is an exemplary diagram showing a relationship between a player and a picture in the player according to this embodiment. In this embodiment, after a source video proportion a is determined, as shown in FIG. 4, a picture in the player shows two play effects. In FIG. 4, A shows that the play picture is played in a full-screen manner in the player (that is, a length-to-width ratio of the player is the same as the source video proportion of the video), and B shows that there is extra space in the width of the player (that is, the length-to-width ratio of the player is greater than the source video proportion of the video).

After the size of the player is determined, to make a picture effect of the video played by the player better, the picture size played in the player is further adjusted in this embodiment. For example, a size of a video play picture in the player is dynamically adjusted, so that the video play picture is shown in the player with a maximum picture size in the source video proportion of the video. For example, when a user retracts or expands a video play list located in the player, the size of the video play picture may be adaptively adjusted, so that the size of the play picture is enlarged when the video play list is retracted, and the size of the play picture is diminished when the video play list is expanded, where the source video proportion remains unchanged during the enlargement and the diminishing.

The method for configuring a video player in a web page provided in this embodiment, based on the embodiment shown in FIG. 1, further provides an implementation example where a width of a player is adjusted by a width of a browser, and a height of the player is determined by the width of the player and heights of a title navigation area and an interactive bar area in the browser, so that the player automatically changes adapting to a change in a size of an initial screen of the browser, thereby providing a user with a more optimized effect of viewing a video.

FIG. 5 is a schematic structural diagram of an apparatus for configuring a video player in a web page according to an embodiment of the present disclosure. The apparatus shown in FIG. 5 may be used to execute the method steps of the embodiment shown in FIG. 1.

Referring to FIG. 5, the apparatus for configuring a video player in a web page specifically includes a size acquiring module 510 and a size adjustment module 520.

The size acquiring module 510 is configured to acquire in real time a size of an initial screen of a browser, in response to an operation of showing a video player playing a video in a web page; and the size adjustment module 520 is configured to set a size of the player according to the size of the initial screen of the browser, so that the player is entirely shown in an initial screen page of the browser.

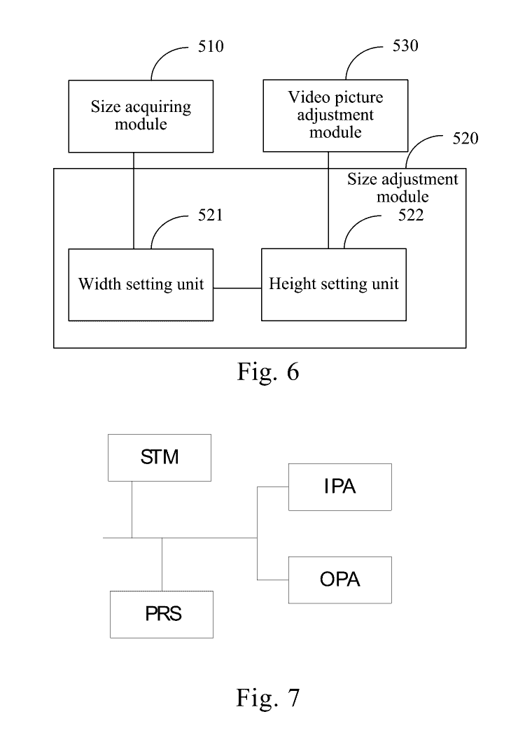

Further the foregoing initial screen of the browser includes a title navigation area and an interactive bar area. Based on this, as shown in FIG. 6, the size adjustment module 520 may include: a width setting unit 521 configured to set a width of the player according to a width of the initial screen of the browser; and a height setting unit 522 configured to set a height of the player according to the width of the player, a height of the browser, and heights of the title navigation area and the interactive bar area.

Further, the foregoing width setting unit 521 is specifically configured to identify a preset width range to which the width of the initial screen of the browser belongs, and to determine a player width threshold that corresponds to the corresponding width range to be a current width of the player, where each preset width range corresponds to one player width threshold, and the larger a width value of the preset width range is, the larger the corresponding player width threshold is.

Further, the foregoing height setting unit 522 may include: a calculation subunit configured to calculate a difference by subtracting the heights of the title navigation area and the interactive bar area from the height of the browser; and a height determining subunit configured to: if the height difference is less than or equal to a first threshold, determine the first threshold to be the height of the player; or if the height difference is greater than the first threshold and is less than a second threshold, determine the height difference to be the height of the player; or if the height difference is greater than or equal to a second threshold, determine the second threshold to be the height of the player, where the second threshold is a ratio of the width of the player to a source video proportion of the video played by the player.

In one embodiment, the foregoing apparatus for configuring a video player in a web page may further include a video picture adjustment module 530 configured to dynamically adjust a size of a video play picture in the player after finishing setting the size of the player, so that the video play picture is shown in the player with a maximum picture size in the source video proportion of the video.

The method embodiment shown in FIG. 2 may be implemented by an apparatus for configuring a video player in a web page shown in FIG. 6, and steps and the principle thereof are not repeated herein.

The apparatus for configuring a video player in a web page provided in this embodiment adjusts a size of a player by checking and acquiring in real time a size of an initial screen of a browser, to ensure that the player is entirely shown in an initial screen page of the browser, thereby meeting a requirement of a user for viewing a complete video picture.

Further, in the apparatus embodiment shown in FIG. 6, an implementation example is provided, where a width of a player is adjusted by a width of a browser, and a height of the player is determined by the width of the player and heights of a title navigation area and an interactive bar area in the browser, so that the player automatically changes adapting to a change in a size of an initial screen of the browser, thereby providing a user with a more optimized effect of viewing a video.

According to an embodiment of the present disclosure, there is provided with a non-transitory computer-readable storage medium storing executable instructions that, when executed by an electronic apparatus, cause the electronic apparatus to perform any of the above disclosed methods.

FIG. 7 illustrates a schematic hardware diagram of an electronic device for performing any of the above disclosed method. According to FIG. 7, the electronic device includes one or more processors PRS and a storage medium STM. FIG. 7 shows one processor PRS as an example.

The electronic device can further include an input apparatus IPA and an output apparatus OPA.

The one or more processors PRS, storage medium STM and output apparatus OPA may be connected by a bus or other means. FIG. 7 shows a bus as an example for connection.

Storage medium STM is a non-transitory computer-readable medium for storing a non-transitory software program, a non-transitory computer-readable program and module, for example the program instructions/module for a method of configuring a video player in a web page (such as, size acquiring module 510, width setting unit 521, height setting unit 522 and video picture adjustment module 530 shown in FIG. 6). The processor PRS can operate the various functions and data processing of a server to perform the method configuring a video player in a web page described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic device for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic device for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic device for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic device of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic device that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

The foregoing method and apparatus according to some embodiments of the present disclosure may be implemented in hardware or firmware, or may be implemented as software or computer code that can be stored in a recording medium (for example, a CD ROM, a RAM, a floppy disk, a hard disk or a magneto-optical disc), or may be implemented as computer code downloaded from a network that is originally stored in a remote recording medium or a non-transitory machine readable medium and will be stored in a local recording medium. Accordingly, the method described herein can be processed by such software that is stored in a recording medium that uses a general-purpose computer, a special-purpose processor or programmable or special-purpose hardware (for example, an ASIC or an FPGA). It may be understood that a computer, a processor, a microprocessor controller or programmable hardware includes a storage component (for example, a RAM, a ROM, and a flash memory, etc.) that can store or receive software or computer code. When the software or computer code is accessed and executed by the computer, the processor or the hardware, the processing method described herein is implemented. In addition, when the general-purpose computer accesses the code that is used for implementing processing shown herein, execution of the code converts the general-purpose computer to a special-purpose computer configured to execute the processing shown herein.

The foregoing descriptions are merely specific implementation manners of some embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be defined by the claims.

What is claimed is:

1. A method performed by an electronic device for configuring a video player in a web page, comprising:
acquiring in real time a size of an initial screen of a browser, in response to an operation of showing a video player playing a video in a web page; and
setting a size of the player according to the size of the initial screen of the browser, so that the player is entirely shown in an initial screen page of the browser.

2. The method according to claim 1, wherein the initial screen of the browser comprises a title navigation area and an interactive bar area; and
the setting a size of the player according to the size of the initial screen of the browser, so that the player is entirely shown in an initial screen page of the browser comprises:
setting a width of the player according to a width of the initial screen of the browser; and
setting a height of the player according to the width of the player, a height of the browser, and heights of the title navigation area and the interactive bar area.

3. The method according to claim 2, wherein the setting a width of the player according to a width of the initial screen of the browser comprises:
identifying a preset width range to which the width of the initial screen of the browser belongs, and determining a player width threshold that corresponds to the corresponding width range to be a current width of the player, wherein each of the preset width range corresponds to one player width threshold, and the larger a width value of the preset width range is, the larger the corresponding player width threshold is.

4. The method according to claim 2, wherein the setting a height of the player according to the width of the player and heights of the title navigation area and the interactive bar area comprises:
calculating a difference by subtracting the heights of the title navigation area and the interactive bar area from the height of the browser;
if the height difference is less than or equal to a first threshold, determining the first threshold to be the height of the player; or
if the height difference is greater than the first threshold and is less than a second threshold, determining the height difference to be the height of the player; or
if the height difference is greater than or equal to the second threshold, determining the second threshold to be the height of the player,
wherein the second threshold is a ratio of the width of the player to a source video proportion of the video played by the player.

5. The method according to claim 1, after finishing the setting a size of the player, further comprising:
dynamically adjusting a size of a video play picture in the player, so that the video play picture is shown in the player with a maximum picture size in the source video proportion of the video.

6. A non-transitory computer-readable storage medium storing executable instructions that, when executed by an electronic device, cause the electronic device to:
acquire in real time a size of an initial screen of a browser, in response to an operation of showing a video player playing a video in a web page; and
set a size of the player according to the size of the initial screen of the browser, so that the player is entirely shown in an initial screen page of the browser.

7. The storage medium according to claim 6, wherein the initial screen of the browser comprises a title navigation area and an interactive bar area; and
wherein to set a size of the player according to the size of the initial screen of the browser, the storage medium further comprises instructions to:
set a width of the player according to a width of the initial screen of the browser; and
set a height of the player according to the width of the player, a height of the browser, and heights of the title navigation area and the interactive bar area.

8. The storage medium according to claim 7, wherein to set a width of the player according to a width of the initial screen of the browser, the storage medium further comprises instructions to:
identify a preset width range to which the width of the initial screen of the browser belongs; and
determine a player width threshold that corresponds to the corresponding width range to be a current width of the player;
wherein each of the preset width range corresponds to one player width threshold, and wherein the larger a width value of the preset width range is, the larger the corresponding player width threshold is.

9. The storage medium according to claim 7, wherein to set a height of the player according to the width of the player and heights of the title navigation area and the interactive bar area, the storage medium further comprises instructions to:
calculate a difference by subtracting the heights of the title navigation area and the interactive bar area from the height of the browser;
if the height difference is less than or equal to a first threshold, determine the first threshold to be the height of the player; or
if the height difference is greater than the first threshold and is less than a second threshold, determine the height difference to be the height of the player; or
if the height difference is greater than or equal to the second threshold, determine the second threshold to be the height of the player;
wherein the second threshold is a ratio of the width of the player to a source video proportion of the video played by the player.

10. The storage medium according to claim 6, wherein the storage medium further comprises instructions to:
dynamically adjust a size of a video play picture in the player, so that the video play picture is shown in the player with a maximum picture size in the source video proportion of the video.

11. An electronic device, comprising:
at least one processor and a memory communicably connected with the at least one processor for storing instructions executable by the at least one processor;
wherein execution of the instructions by the at least one processor causes the at least one processor to:
acquire in real time a size of an initial screen of a browser, in response to an operation of showing a video player playing a video in a web page; and
set a size of the player according to the size of the initial screen of the browser, so that the player is entirely shown in an initial screen page of the browser.

12. The electronic device according to claim 11, wherein the initial screen of the browser comprises a title navigation area and an interactive bar area; and
wherein to set a size of the player according to the size of the initial screen of the browser, the at least one processor is further caused to:
set a width of the player according to a width of the initial screen of the browser; and
set a height of the player according to the width of the player, a height of the browser, and heights of the title navigation area and the interactive bar area.

13. The electronic device according to claim 12, wherein to set a width of the player according to a width of the initial screen of the browser, the at least one processor is further caused to:
identify a preset width range to which the width of the initial screen of the browser belongs; and
determine a player width threshold that corresponds to the corresponding width range to be a current width of the player;
wherein each of the preset width range corresponds to one player width threshold, and wherein the larger a width value of the preset width range is, the larger the corresponding player width threshold is.

14. The electronic device according to claim 12, wherein to set a height of the player according to the width of the player and heights of the title navigation area and the interactive bar area, the at least one processor is further caused to:
calculate a difference by subtracting the heights of the title navigation area and the interactive bar area from the height of the browser;
if the height difference is less than or equal to a first threshold, determine the first threshold to be the height of the player; or
if the height difference is greater than the first threshold and is less than a second threshold, determine the height difference to be the height of the player; or
if the height difference is greater than or equal to the second threshold, determine the second threshold to be the height of the player;
wherein the second threshold is a ratio of the width of the player to a source video proportion of the video played by the player.

15. The electronic device according to claim 11, wherein the at least one processor is further caused to:
dynamically adjust a size of a video play picture in the player, so that the video play picture is shown in the player with a maximum picture size in the source video proportion of the video.
